(19) United States
(12) Patent Application Publication
(10) Pub. No.: US 2022/0167208 A1
(43) Pub. Date: May 26, 2022

(54) DATA TRANSMISSION METHOD

(71) Applicant: VIVO MOBILE COMMUNICATION CO.,LTD., Guangdong (CN)

(72) Inventor: Yumin WU, Guangdong (CN)

(73) Assignee: VIVO MOBILE COMMUNICATION CO.,LTD., Guangdong (CN)

(21) Appl. No.: 17/669,898

(22) Filed: Feb. 11, 2022

Related U.S. Application Data
(63) Continuation of application No. PCT/CN2020/107391, filed on Aug. 6, 2020.

(30) Foreign Application Priority Data
Aug. 14, 2019 (CN) 201910750598.9

(51) Int. Cl. H04W 28/02; H04L 5/00; H04W 4/06; H04W 4/021

(52) U.S. Cl. CPC H04W 28/0278; H04W 28/0226; H04W 4/021; H04L 5/0048; H04W 4/06; H04W 28/0257

(57) ABSTRACT

A data transmission method includes: obtaining a quantity of terminal devices and geographical location information of a terminal device, where the terminal device is a terminal device that receives target service data in a first transmission manner; and determining, based on the quantity of terminal devices and the geographical location information of the terminal device, to switch the first transmission manner to a second transmission manner, so that the target service data is sent to the terminal device in the second transmission manner.

### CROSS-REFERENCE TO RELATED APPLICATIONS

This application is a Bypass Continuation Application of PCT/CN2020/107391, filed on Aug. 6, 2020, which claims priority to Chinese Patent Application No. 201910750598.9, filed on Aug. 14, 2019, which are incorporated herein by reference in their entirety.

### TECHNICAL FIELD

The present disclosure relates to the field of communications technologies, and in particular, to a data transmission method and apparatus, a device, and a medium.

### BACKGROUND

Currently, a base station may send data to a terminal device through multicast or unicast. For a specific service, if many terminals receive data of the specific service, and the data of the specific service is sent to the terminal device through unicast, physical channel resources are wasted. If fewer terminals receive the data of the specific service, and the data of the specific service is sent to the terminal device through multicast, resource utilization is relatively low.

### SUMMARY

Embodiments of the present disclosure provide a data transmission method and apparatus, a device, and a medium.

According to a first aspect, an embodiment of the present disclosure provides a data transmission method applied to a network side device, including:

obtaining a quantity of terminal devices and geographical location information of the terminal device, where the terminal device is a terminal device that receives target service data in a first transmission manner; and

determining, based on the quantity of terminal devices and the geographical location information of the terminal device, to switch the first transmission manner to a second transmission manner, so that the network side device sends the target service data to the terminal device in the second transmission manner.

According to a second aspect, an embodiment of the present disclosure provides a data transmission method applied to a network node, including:

receiving first configuration information sent by a network side device;

establishing a data service channel based on the first configuration information, where the data service channel is used to carry target service data sent in a second transmission manner; and

sending the target service data to a terminal device in the second transmission manner based on the data service channel.

According to a third aspect, an embodiment of the present disclosure provides a data transmission method applied to a terminal device, including:

receiving second configuration information and/or first indication information sent by a network side device;

configuring, based on the second configuration information, to receive target service data in a second transmission manner; and

receiving, based on the first indication information, the target service data sent in the second transmission manner.

According to a fourth aspect, an embodiment of the present disclosure provides a data transmission apparatus applied to a network side device, including:

an obtaining module, configured to obtain a quantity of terminal devices and geographical location information of the terminal device, where the terminal device is a terminal device that receives target service data in a first transmission manner; and

a determining module, configured to determine, based on the quantity of terminal devices and the geographical location information of the terminal device, to switch the first transmission manner to a second transmission manner, so that the network side device sends the target service data to the terminal device in the second transmission manner.

According to a fifth aspect, an embodiment of the present disclosure provides a data transmission apparatus applied to a network node, including:

a first receiving module, configured to receive first configuration information sent by a network side device;

an establishing module, configured to establish a data service channel based on the first configuration information, where the data service channel is used to carry target service data sent in a second transmission manner; and

a third sending module, configured to send the target service data to a terminal device in the second transmission manner based on the data service channel.

According to a sixth aspect, an embodiment of the present disclosure provides a data transmission apparatus applied to a terminal device, including:

a second receiving module, configured to receive second configuration information and/or first indication information sent by a network side device;

a configuration module, configured to configure, based on the second configuration information, to receive target service data in a second transmission manner; and

a third receiving module, configured to receive, based on the first indication information, the target service data sent in the second transmission manner.

According to a seventh aspect, an embodiment of the present disclosure provides a network side device. The network side device includes a processor, a memory, and a computer program that is stored in the memory and executable on the processor, and when the computer program is executed by the processor, the steps of the data transmission method provided in the first aspect in the embodiments of the present disclosure are implemented.

According to an eighth aspect, an embodiment of the present disclosure provides a network node. The network node includes a processor, a memory, and a computer program that is stored in the memory and executable on the processor, and when the computer program is executed by the processor, the steps of the data transmission method provided in the second aspect in the embodiments of the present disclosure are implemented.

According to a ninth aspect, an embodiment of the present disclosure provides a terminal device. The terminal device includes a processor, a memory, and a computer program that is stored in the memory and executable on the processor, and when the computer program is executed by the processor, the steps of the data transmission method provided in the third aspect in the embodiments of the present disclosure are implemented.

According to a tenth aspect, an embodiment of the present disclosure provides a computer-readable storage medium. The computer-readable storage medium stores a computer program, and when the computer program is executed by a processor, the steps of the data transmission method provided in the first aspect or the second aspect or the third aspect in the embodiments of the present disclosure are implemented.

### BRIEF DESCRIPTION OF DRAWINGS

To describe the technical solutions in the embodiments of the present disclosure more clearly, the following briefly describes the accompanying drawings required to be used in the embodiments of the present disclosure. A person of ordinary skill in the art may still derive other drawings from these accompanying drawings.

FIG. 1 is a schematic flowchart of a data transmission method applied to a network side device according to an embodiment of the present disclosure;

FIG. 2 is a schematic flowchart of a data transmission method applied to a network node according to an embodiment of the present disclosure;

FIG. 3 is a schematic flowchart of a data transmission method applied to a terminal device according to an embodiment of the present disclosure;

FIG. 4 is a schematic structural diagram of a data transmission apparatus applied to a network side device according to an embodiment of the present disclosure;

FIG. 5 is a schematic structural diagram of a data transmission apparatus applied to a network node according to an embodiment of the present disclosure;

FIG. 6 is a schematic structural diagram of a data transmission apparatus applied to a terminal device according to an embodiment of the present disclosure;

FIG. 7 is a schematic diagram of a hardware structure of a network side device according to an embodiment of the present disclosure;

FIG. 8 is a schematic diagram of a hardware structure of a network node according to an embodiment of the present disclosure; and

FIG. 9 is a schematic diagram of a hardware structure of a terminal device according to an embodiment of the present disclosure.

### DESCRIPTION OF EMBODIMENTS

To make the objects, technical solutions, and beneficial technical effects of the present disclosure clearer, the following describes the present disclosure in detail with reference to specific embodiments. It should be understood that the embodiments described in this specification are merely intended to explain the present disclosure, and are not intended to limit the present disclosure.

For simplicity, only some numerical ranges are explicitly disclosed in this specification. However, any lower limit may be combined with any upper limit to form an unspecified range; and any lower limit may be combined with another lower limit to form an unspecified range, and any upper limit may also be combined with any other upper limit to form an unspecified range. In addition, although not explicitly documented, each point or a single value between endpoints of a range is included in the range. Thus, each point or a single value may be combined with any other point or single value as a lower or upper limit of the point or single value or may be combined with another lower or upper limit to form an unspecified range.

In the descriptions of this specification, it should be noted that, unless otherwise stated, “more than xx” or “less than xx” means that xx is included, and “several” in “one or more” means two or more.

The foregoing summary of the present disclosure is not intended to describe each disclosed implementation or each implementation in the present disclosure. The following descriptions illustrate exemplary implementations in detail. Throughout the entire application, a series of embodiments provide guidance, and these embodiments may be combined in various forms. Examples are enumerated as representative only and should not be interpreted as exhaustive.

Embodiments of the present disclosure provide a data transmission method and apparatus, a device, and a medium. The following first describes the data transmission method in detail provided in the embodiments of the present disclosure.

FIG. 1 is a schematic flowchart of a data transmission method applied to a network side device according to an embodiment of the present disclosure. The data transmission method applied to the network side device may include the following steps.

S101. Obtain a quantity of terminal devices and geographical location information of the terminal device.

The terminal device is a terminal device that receives target service data in a first transmission manner.

S102: Determine, based on the quantity of terminal devices and the geographical location information of the terminal device, to switch a first transmission manner to a second transmission manner, so that the network side device sends target service data to the terminal device in the second transmission manner.

The network side device provided in this embodiment of the present disclosure may be a base station, and the base station may be a commonly used base station, or may be an evolved NodeB (eNB), or may be a network side device in a 5G system (such as a next generation NodeB (gNB)) or a network side device in a subsequent evolved communications system. However, the foregoing words do not constitute a limitation on the protection scope of the present disclosure.

The network side device provided in this embodiment of the present disclosure may be alternatively a gateway, for example, a serving gateway (S-GW), a public data network gateway (P-SW), and a user plane function (UPF) gateway.

The network side device provided in this embodiment of the present disclosure may be alternatively a mobility management entity (MME), or may be a session management function (SMF).

For example, assuming that the network side device counts that a quantity of terminal devices that receive the target service data service 1 through unicast in a cell 1 is greater than a preset quantity, it is determined to switch unicast to multicast.

For another example, assuming that the network side device counts that a quantity of terminal devices that receive the target service data service 1 through multicast in a cell 1 is less than a preset quantity, it is determined to switch multicast to unicast.

In an embodiment of the present disclosure, the network side device may further determine, based on the quantity of terminal devices and the geographical location information of the terminal device, a network node that switches the first transmission manner to the second transmission manner. The network node sends the target service data to the terminal device in the second transmission manner, and the terminal device receives, in the second transmission manner, the target service data sent by the network node. The network node is a network node that manages or serves the terminal device.

The network node in this embodiment of the present disclosure may also be a base station, a network, a mobility management entity, or a session management entity.

In an embodiment of this disclosure, the network side device provided in this embodiment of the present disclosure may further send first configuration information to the network node. The first configuration information is used by the network node to establish a data service channel, and the data service channel is used to carry the target service data sent in the second transmission manner.

In an embodiment of the present disclosure, the network side device provided in this embodiment of the present disclosure may further send second configuration information to the terminal device, where the second configuration information is used by the terminal device to configure to receive the target service data in the second transmission manner.

In an embodiment of the present disclosure, the network side device provided in this embodiment of the present disclosure may further send first indication information to the terminal device, where the first indication information is used to instruct the terminal device to receive the target service data sent by the network node in the second transmission manner.

The first transmission manner in this embodiment of the present disclosure may be unicast, and the second transmission manner may be multicast; or the first transmission manner is multicast, and the second transmission manner is unicast.

The following separately describes the data transmission method corresponding to the case that the first transmission manner is unicast and the second transmission manner is multicast and the data transmission method corresponding to the case that the first transmission manner is multicast and the second transmission manner is unicast.

When the first transmission manner is unicast, and the second transmission manner is multicast, assuming that the network side device counts that a quantity of terminal devices that receive the target service data service 1 through unicast in a cell 1 is greater than a preset quantity, and that a quantity of terminal devices that receive the target service data service 1 through unicast in a cell 2 is less than the preset quantity, the network side device determines that a network node that switches unicast to multicast is a base station 1 corresponding to the cell 1, sends, to the base station 1, first configuration information used to establish a data service channel that carries the service 1 sent through multicast, and sends, to the terminal device that receives the service 1 through unicast, second configuration information used to configure to receive the service 1 through multicast and first indication information used to instruct the terminal device to receive the service 1 sent by the base station 1 through multicast. The base station 1 establishes, based on the first configuration information, the data service channel used to carry the service 1 sent through multicast, and sends the service 1 to the terminal device based on the data service channel through multicast; and the terminal device is configured, based on the second configuration information, to receive the service 1 through multicast, and receives, based on the first indication information, the service 1 sent by the base station 1 through multicast.

The geographical location information of the terminal device may include at least one of the following items: a frequency currently used for receiving a unicast service, a current cell, a current working area mobile network (public land mobile network, PLMN), a current tracking area (TA), a current corresponding base station, a current corresponding gateway, a current corresponding MME, or a current corresponding SMF.

In an embodiment of the present disclosure, the network side device may determine the quantity of terminal devices based on a quantity of bearers that are established with the terminal device for the target service data.

For example, assuming that 10 terminal devices establish bearers with the network side device for the target service data service 1, it is determined that 10 terminal devices receive the service 1 through unicast.

In an embodiment of the present disclosure, a bearer type for the target service data may include any one of the following items:

a quality of service (QoS) flow, a protocol data unit (PDU) session, a data radio bearer (DRB), and an evolved packet system (EPS) bearer.

In an embodiment of the present disclosure, the network side device may send the second configuration information to the terminal device by using broadcast signaling or dedicated signaling. The broadcast signaling is, for example, a system information block (SIB) 10. The dedicated signaling is, for example, a radio resource control (RRC) message.

In an embodiment of the present disclosure, the second configuration information may include configuration information of a multimedia broadcast multicast service single frequency network (MBSFN) sending manner and/or configuration information of a single cell point to multipoint (SC-PTM) sending manner.

The configuration information of the MBSFN sending manner may include configuration information of a control channel in the MBSFN sending manner and configuration information of a data channel in the MBSFN sending manner. The configuration information of the control channel in the MBSFN sending manner is, for example, a receive time-frequency location of a multicast control channel (MCCH) and a coding scheme of the MCCH. The coding scheme is, for example, a modulation and coding scheme (MCS). The configuration information of the data channel in the MBSFN sending manner is, for example, a receive time-frequency location of a multicast traffic channel (MTCH) and a coding scheme of the MTCH.

The configuration information of the SC-PTM sending manner may include configuration information of a control channel in the SC-PTM sending manner and configuration information of a data channel in the SC-PTM sending manner. The configuration information of the control channel in the SC-PTM sending manner is, for example, a receive time-frequency location of a single cell-multicast control channel (SC-MCCH) and a coding scheme of the SC-MCCH. The configuration information of the data channel in the SC-PTM sending manner is, for example, a receive time-frequency location of a single cell-multicast traffic channel (SC-MTCH) and a coding scheme of the SC-MTCH. Identifier information of the SC-MTCH is, for example, a radio network temporary identifier (RNTI).

In an embodiment of the present disclosure, the first indication information may include at least one of the following items:

a correspondence between a unicast data channel and a multicast data channel of the target service data; service identifier information that is to be used for sending though multicast; service identifier information that is currently used for sending though unicast; indication information indicating that sending of the target service data through unicast is about to stop; or indication information indicating that sending of the target service data though multicast is to be started.

The indication information indicating that sending of the target service data through unicast is about to stop is, for example, indicating that a DRB is about to stop.

The indication information indicating that sending of the target service data though multicast is to be started is, for example, a temporary mobile group identity (TMGI) starts in 2 seconds, and for another example, a TMGI starts at xx: xx: xx on DD/MM/YY.

In an embodiment of the present disclosure, the correspondence between the unicast data channel and the multicast data channel of the target service may include at least one of the following items: a correspondence between a data radio bearer and a multicast radio bearer (MRB); a correspondence between a unicast session and a multicast session; a correspondence between a unicast data flow and a multicast data flow; a correspondence between a data radio bearer and multicast service identifier information; a correspondence between a unicast data flow and a multicast service identifier; or a correspondence between a unicast session and a multicast service identifier.

The correspondence between the data radio bearer and the multicast radio bearer is, for example, a correspondence between a DRB1 and an MRB1.

The correspondence between the unicast session and the multicast session, for example, a correspondence between a unicast PDU session 1 and a multicast PDU session 1.

The correspondence between the unicast data flow and the multicast data flow is, for example, a correspondence between a unicast QoS flow 1 and a multicast QoS flow 1.

The correspondence between the data radio bearer and the multicast service identifier information is, for example, a correspondence between a DRB 1 and a multicast TMGI 1 or a correspondence between a DRB 1 and a service area identity (SAI) 1.

The correspondence between the unicast data flow and the multicast service identifier is, for example, a correspondence between a unicast QoS flow 1 and a multicast TMGI 1.

The correspondence between the unicast session and the multicast service identifier is, for example, a correspondence between a unicast PDU session 1 and a multicast TMGI 1.

When the first transmission manner is multicast, and the second transmission manner is unicast, assuming that the network side device counts that a quantity of terminal devices that receive the target service data service 1 through multicast in a cell 1 is less than a preset quantity, the network side device determines to send the service 1 through unicast, determines that a network node is a base station 1 corresponding to the cell 1, sends, to the base station 1, first configuration information used to establish a data service channel that carries the service 1 sent through unicast, and sends, to the terminal device that receives the service 1 through multicast, second configuration information used to configure to receive the service 1 through unicast and first indication information used to instruct the terminal device to receive the service 1 sent by the base station 1 through unicast. The base station 1 establishes, based on the first configuration information, the data service channel used to carry the service 1 sent through unicast, and sends the service 1 to the terminal device based on the data service channel through unicast; and the terminal device is configured, based on the second configuration information, to receive the service 1 through unicast, and receives, based on the first indication information, the service 1 sent by the base station 1 through unicast.

The geographical location information of the terminal device may include at least one of the following items: a frequency currently used for receiving a multicast service, a current cell, a current multicast service serving area, or a current multicast area.

In an embodiment of the present disclosure, the network side device may send multicast service statistics request information for the target service data to the terminal device; receive a request response that is for the multicast service statistics request information sent by the terminal device; and count a quantity of terminal devices that receive the target service data through multicast.

For example, the network side device sends the multicast service statistics request information for the target service data to 50 terminal devices by using a multicast control channel (MCCH) or a dedicated control channel (DCCH), where the multicast service statistics request information includes multicast service identifier information (for example, a TMGI 1), and a request response fed back by 45 terminal devices includes the TMGI 1. Therefore, the quantity of terminal devices that receive the target service data through multicast is 45.

In an embodiment of the present disclosure, the terminal device may further spontaneously send a first message to the network side device, and the network side device receives the first message, and counts, based on the first message, a quantity of terminal devices that receive the target service data through multicast.

In an embodiment of the present disclosure, the first message may include at least one of the following items: identifier information of a multicast service that is currently being received (for example, the terminal device reports a TMGI 1 that is currently being received), identifier information of a to-be-received multicast service (for example, the terminal device reports a to-be-received TMGI 1), identifier information of a multicast service that is not currently received (for example, the terminal device reports a TMGI 1 that is not currently received), identifier information of a multicast service that is not to be received (for example, the terminal device reports a TMGI 1 that is not to be received), or identifier information of a multicast service that has been received (for example, the terminal device reports a TMGI 1 that has been received).

In an embodiment of the present disclosure, the terminal device may further report a geographical location of the terminal device to the network side device (that is, report geographical location information of the terminal device).

In an embodiment of the present disclosure, the network side device may send the second configuration information to the terminal device by using dedicated signaling. The dedicated signaling is, for example, an RRC message.

In an embodiment of the present disclosure, the first indication information may include at least one of the following items:

a correspondence between a unicast data channel and a multicast data channel of the target service data; service identifier information that is to be used for sending though unicast; service identifier information that is currently used for sending though multicast; indication information indicating that sending of the target service data through multicast is to be stopped; or indication information indicating that sending of the target service data though unicast is to be started.

The indication information indicating that sending of the target service data through multicast is about to stop is, for example, indicating that an MRB is about to stop. For another example, a TMGI stops in 2 seconds. For another example, a TMGI stops at xx: xx: xx on DD/MM/YY.

In an embodiment of the present disclosure, the correspondence between the unicast data channel and the multicast data channel of the target service data may include at least one of the following items: a correspondence between a DRB and an MRB; a correspondence between a unicast session and a multicast session; a correspondence between a unicast data flow and a multicast data flow; a correspondence between a data radio bearer and multicast service identifier information; a correspondence between a unicast data flow and a multicast service identifier; or a correspondence between a unicast session and a multicast service identifier.

The correspondence between the DRB and the MRB is, for example, a correspondence between a DRB 1 and an MRB 1.

The correspondence between the unicast session and the multicast session, for example, a correspondence between a unicast PDU session 1 and a multicast PDU session 1.

The correspondence between the unicast data flow and the multicast data flow is, for example, a correspondence between a unicast QoS flow 1 and a multicast QoS flow 1.

The correspondence between the data radio bearer and the multicast service identifier information is, for example, a correspondence between a DRB 1 and a multicast TMGI 1 or a correspondence between a DRB 1 and an SAI 1.

The correspondence between the unicast data flow and the multicast service identifier is, for example, a correspondence between a unicast QoS flow 1 and a multicast TMGI 1.

The correspondence between the unicast session and the multicast service identifier is, for example, a correspondence between a unicast PDU session 1 and a multicast TMGI 1.

In an embodiment of the present disclosure, the network side device may send the target service data to the terminal device in the second transmission manner. The terminal device receives the target service data sent by the network side device in the second transmission manner.

In an embodiment of the present disclosure, before sending the target service data to the terminal device in the second transmission manner, the network side device may stop sending the target service data to the terminal device in the first transmission manner.

For example, assuming that the first transmission manner is unicast and the second transmission manner is multicast, before the target service data is sent to the terminal device through multicast, the network side device stops sending the target service data to the terminal device through unicast.

For another example, assuming that the first transmission manner is multicast and the second transmission manner is unicast, before the target service data is sent to the terminal device through unicast, the network side device stops sending the target service data to the terminal device through multicast.

In an embodiment of the present disclosure, the stopping sending the target service data to the terminal device in a first transmission manner may include at least one of the following items: deleting a radio bearer of the first transmission manner of the target service data, deleting an EPS bearer of the first transmission manner of the target service data, deleting a QoS flow of the first transmission manner of the target service data, deleting a PDU session of the first transmission manner of the target service data, or deleting the target service data.

When the first transmission manner is unicast, a unicast DRB of the target service data is deleted.

When the first transmission manner is multicast, a multicast MRB of the target service data is deleted.

In an embodiment of the present disclosure, before stopping sending the target service data to the terminal device in the first transmission manner, the network side device may receive second indication information sent by the terminal device, where the second indication information indicates that the terminal device has been configured to receive the target service data in the second transmission manner. After receiving the second indication information, the network side device may stop sending the target service data to the terminal device in the first transmission manner, and then send the target service data to the terminal device in the second transmission manner.

If the terminal device does not send the second indication information to the network side device, and the network side device does not receive the second indication information, the network side device stops sending the target service data to the terminal device in the first transmission manner, and then sends the target service data to the terminal device in the second transmission manner. In this case, the terminal device may fail to receive the target service data.

In an embodiment of the present disclosure, the second indication information may include at least one of the following items: terminal device identifier information, unicast bearer identifier information, multicast bearer identifier information, multicast service identifier information, cell identifier information for carrying a multicast service, or frequency identifier information for carrying a multicast service.

The terminal device identifier information is, for example, an international mobile subscriber identity (IMSI) and a temporary mobile station identifier (TMSI).

The unicast bearer identifier information is, for example, a DRB1, a unicast QoS flow 1, and a unicast PDU session 1.

The multicast bearer identifier information is, for example, an MRB 1.

The multicast service identifier information is, for example, a TMGI 1.

In an embodiment of the present disclosure, before stopping sending the target service data to the terminal device in the first transmission manner, the network side device may send the target service data to the terminal device in the second transmission manner and the first transmission manner.

In an embodiment of the present disclosure, before stopping sending the target service data to the terminal device in the first transmission manner, the network side device may further receive third indication information sent by the terminal device, where the third indication information is used to indicate that the terminal device has stopped receiving the target service data in the first transmission manner. After receiving the third indication information, the network side device may stop sending the target service data to the terminal device in the first transmission manner, and then send the target service data to the terminal device in the second transmission manner.

According to the data transmission method in this embodiment of the present disclosure, the network side device determines, based on the quantity of terminal devices receiving the target service data in the first transmission manner and the geographical location information of the terminal device, to switch the first transmission manner to the second transmission manner, and then send the target service data to the terminal device in the second transmission manner. In this way, data transmission manners can be switched and resources can be saved, thereby improving resource utilization.

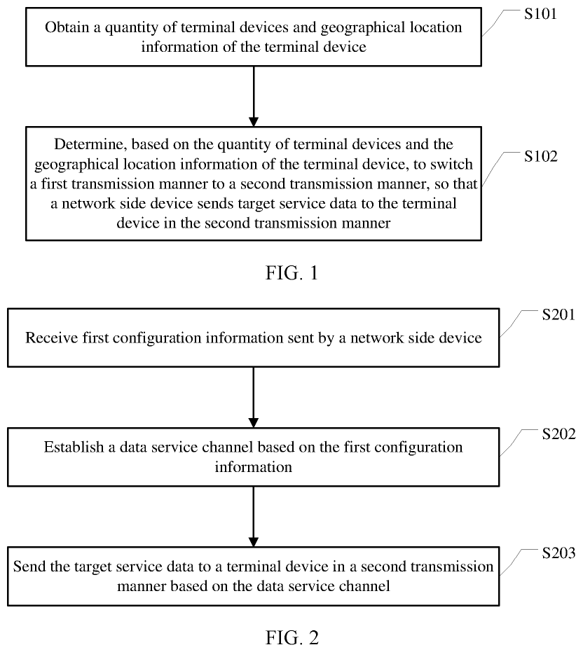

FIG. 2 is a schematic flowchart of a data transmission method applied to a network node according to an embodiment of the present disclosure. The data transmission method applied to the network node may include the following steps.

S201: Receive first configuration information sent by a network side device.

S202. Establish a data service channel based on the first configuration information.

The data service channel is used to carry the target service data sent in the second transmission manner.

S203: Send the target service data to a terminal device in a second transmission manner based on the data service channel.

For example, it is assumed that before receiving the first configuration information sent by the network side device, the network node sends the target service data to the terminal device through unicast. After the first configuration information sent by the network side device is received, a data service channel that is used to carry the target service data sent through multicast is established, and the target service data is sent to the terminal device through multicast based on the data service channel.

For another example, it is assumed that before receiving the first configuration information sent by the network side device, the network side device sends the target service data to the terminal device through multicast. After the first configuration information sent by the network side device is received, a data service channel that is used to carry the target service data sent through unicast is established, and the target service data is sent to the terminal device through unicast based on the data service channel.

In an embodiment of the present disclosure, before the network node sends the target service data to the terminal device in the second transmission manner, the network node may stop sending the target service data to the terminal device in the first transmission manner.

For example, assuming that the first transmission manner is unicast and the second transmission manner is multicast, before the target service data is sent to the terminal device through multicast, the network node stops sending the target service data to the terminal device through unicast.

For another example, assuming that the first transmission manner is multicast and the second transmission manner is unicast, before the target service data is sent to the terminal device through unicast, the network node stops sending the target service data to the terminal device through multicast.

In an embodiment of the present disclosure, the stopping sending the target service data to the terminal device in a first transmission manner may include at least one of the following items: deleting a radio bearer of the first transmission manner of the target service data, deleting an EPS bearer of the first transmission manner of the target service data, deleting a QoS flow of the first transmission manner of the target service data, deleting a PDU session of the first transmission manner of the target service data, or deleting the target service data.

When the first transmission manner is unicast, a unicast DRB of the target service data is deleted.

When the first transmission manner is multicast, a multicast MRB of the target service data is deleted.

In an embodiment of the present disclosure, before stopping sending the target service data to the terminal device in the first transmission manner, the network node may receive fourth indication information sent by the terminal device, where the fourth indication information indicates that the terminal device has been configured to receive the target service data in the second transmission manner. After receiving the fourth indication information, the network node may stop sending the target service data to the terminal device in the first transmission manner, and then send the target service data to the terminal device in the second transmission manner.

If the terminal device does not send the fourth indication information to the network node, and the network node does not receive the fourth indication information, the network node stops sending the target service data to the terminal device in the first transmission manner, and then sends the target service data to the terminal device in the second transmission manner. In this case, the terminal device may fail to receive the target service data.

In an embodiment of the present disclosure, the fourth indication information may include at least one of the following items: terminal device identifier information, unicast bearer identifier information, multicast bearer identifier information, multicast service identifier information, cell identifier information for carrying a multicast service, or frequency identifier information for carrying a multicast service.

The terminal device identifier information is, for example, an IMSI and a TMSI.

The unicast bearer identifier information is, for example, a DRB1, a unicast QoS flow 1, and a unicast PDU session 1.

The multicast bearer identifier information is, for example, an MRB 1.

The multicast service identifier information is, for example, a TMGI 1.

In an embodiment of the present disclosure, before stopping sending the target service data to the terminal device in the first transmission manner, the network node may send the target service data to the terminal device in the second transmission manner and the first transmission manner.

In an embodiment of the present disclosure, before stopping sending the target service data to the terminal device in the first transmission manner, the network node may further receive fifth indication information sent by the terminal device, where the fifth indication information is used to indicate that the terminal device has stopped receiving the target service data in the first transmission manner. After receiving the fifth indication information, the network node may stop sending the target service data to the terminal device in the first transmission manner, and then send the target service data to the terminal device in the second transmission manner.

According to the data transmission method in this embodiment of the present disclosure, the network node switches the first transmission manner to the second transmission manner, and sends the target service data to the terminal device in the second transmission manner. In this way, data transmission manners can be switched and resources can be saved, thereby improving resource utilization.

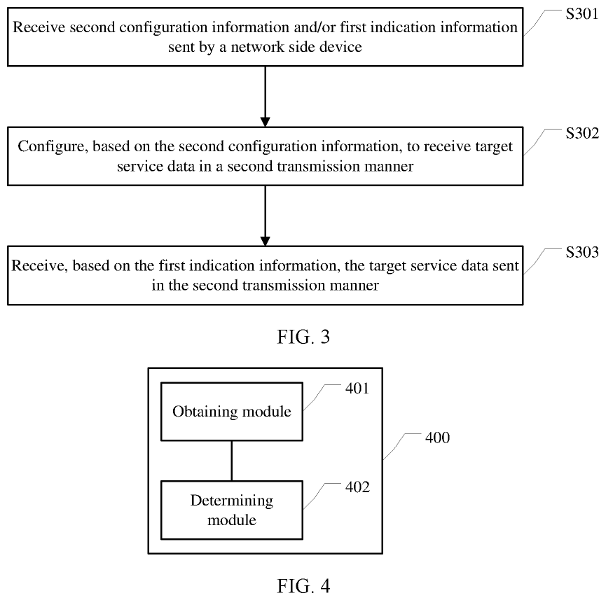

FIG. 3 is a schematic flowchart of a data transmission method applied to a terminal device according to an embodiment of the present disclosure. The data transmission method applied to the terminal device may include the following steps.

S301: Receive second configuration information and/or first indication information sent by a network side device.

S302: Configure, based on the second configuration information, to receive target service data in a second transmission manner.

S303: Receive, based on the first indication information, the target service data sent in the second transmission manner.

Target service data that is received by the terminal device and sent in the second transmission manner may be target service data sent by the network side device in the second transmission manner, or may be target service data sent by a network node in the second transmission manner.

For another example, it is assumed that before receiving the second configuration information and the first indication information that are sent by the network side device, the terminal device receives, through unicast, the target service data sent by the network node. After receiving the second configuration information and the first indication information that are sent by the network side device, the terminal device is configured to receive the target service data through multicast, and receive the target service data sent through multicast.

For another example, it is assumed that before receiving the second configuration information and the first indication information that are sent by the network side device, the terminal device receives, through multicast, the target service data sent by the network node. After receiving the second configuration information and the first indication information that are sent by the network side device, the terminal device is configured to receive the target service data through unicast, and receive the target service data sent through unicast.

In an embodiment of the present disclosure, before receiving the target service data sent in the second transmission manner, the terminal device may stop receiving the target service data sent in the first transmission manner.

For example, assuming that the first transmission manner is unicast and the second transmission manner is multicast, before receiving the target service data sent through multicast, the terminal device stops receiving the target service data sent through unicast.

For example, assuming that the first transmission manner is multicast and the second transmission manner is unicast, before receiving the target service data sent through unicast, the terminal device stops receiving the target service data sent through multicast.

In an embodiment of the present disclosure, the terminal device may actively stop receiving the target service data sent in the first transmission manner. For example, after receiving the second configuration information and the first indication information that are sent by the network side device, the terminal device stops receiving the target service data sent in the first transmission manner.

In an embodiment of the present disclosure, the terminal device may further receive sixth indication information sent by the network side device, and stop receiving, based on the sixth indication information, the target service data sent in the first transmission manner, where the sixth indication information is used to instruct the terminal device to stop receiving the target service data sent in the first transmission manner.

In an embodiment of the present disclosure, that the terminal device stops receiving the target service data sent in the first transmission manner may include at least one of the following items: deleting a radio bearer of the first transmission manner of the target service data, deleting an EPS bearer of the first transmission manner of the target service data, deleting a QoS flow of the first transmission manner of the target service data, deleting a PDU session of the first transmission manner of the target service data, or deleting the target service data.

In an embodiment of the present disclosure, the terminal device stops receiving the target service data sent through multicast, and may further stop receiving the target service data at a specific resource location at which the target service is sent. For example, for a multicast service TMGI 1 sent in an MBSFN manner or an SC-PTM manner, the terminal device stops monitoring scheduling information of the TMGI 1 at a specific time location of a specific frequency f1.

When the first transmission manner is unicast, a unicast DRB of the target service data is deleted.

When the first transmission manner is multicast, a multicast MRB of the target service data is deleted.

In an embodiment of the present disclosure, after stopping receiving the target service data sent in the first transmission manner, the terminal device may send seventh indication information to the network side device and/or the network node where the seventh indication information is used to indicate that the terminal device has stopped receiving the target service data in the first transmission manner.

In an embodiment of the present disclosure, the seventh indication information may include at least one of the following items: a bearer identifier of the first transmission manner, a bearer identifier of the second transmission manner, a service identifier of the second transmission manner, a cell identifier for carrying the second transmission manner, or a frequency identifier for carrying the second transmission manner.

In an embodiment of the present disclosure, before receiving the target service data sent in the second transmission manner, the terminal device may send eighth indication information to the network side device and/or the network node, where the eighth indication information is used to indicate that the terminal device has been configured to receive the target service data in the second transmission manner. After receiving the eighth indication information, the network side device and/or the network node may stop sending the target service data to the terminal device in the first transmission manner, and then send the target service data to the terminal device in the second transmission manner.

In an embodiment of the present disclosure, the eighth indication information may include at least one of the following items: terminal device identifier information, unicast bearer identifier information, multicast bearer identifier information, multicast service identifier information, cell identifier information for carrying a multicast service, or frequency identifier information for carrying a multicast service.

The terminal device identifier information is, for example, an IMSI and a TMSI.

The unicast bearer identifier information is, for example, a DRB1, a unicast QoS flow 1, and a unicast PDU session 1.

The multicast bearer identifier information is, for example, an MRB 1.

The multicast service identifier information is, for example, a TMGI 1.

In an embodiment of the present disclosure, before the terminal device may stop receiving the target service data sent in the first transmission manner, the terminal device may receive the target service data sent in the second transmission manner and the first transmission manner.

In an embodiment of the present disclosure, the first indication information may include at least one of the following items:

a correspondence between a unicast data channel and a multicast data channel of the target service data; service identifier information that is to be used for sending though unicast; service identifier information that is currently used for sending though multicast; indication information indicating that sending of the target service data through multicast is to be stopped; or indication information indicating that sending of the target service data though unicast is to be started.

The indication information indicating that sending of the target service data through multicast is about to stop is, for example, indicating that an MRB is about to stop. For another example, a TMGI stops in 2 seconds. For another example, a TMGI stops at xx: xx: xx on DD/MM/YY.

In an embodiment of the present disclosure, the correspondence between the unicast data channel and the multicast data channel of the target service data may include at least one of the following items: a correspondence between a DRB and an MRB; a correspondence between a unicast session and a multicast session; a correspondence between a unicast data flow and a multicast data flow; a correspondence between a data radio bearer and multicast service identifier information; a correspondence between a unicast data flow and a multicast service identifier; or a correspondence between a unicast session and a multicast service identifier.

The correspondence between the DRB and the MRB is, for example, a correspondence between a DRB 1 and an MRB 1.

The correspondence between the unicast session and the multicast session, for example, a correspondence between a unicast PDU session 1 and a multicast PDU session 1.

The correspondence between the unicast data flow and the multicast data flow is, for example, a correspondence between a unicast QoS flow 1 and a multicast QoS flow 1.

The correspondence between the data radio bearer and the multicast service identifier information is, for example, a correspondence between a DRB 1 and a multicast TMGI 1 or a correspondence between a DRB 1 and an SAI 1.

The correspondence between the unicast data flow and the multicast service identifier is, for example, a correspondence between a unicast QoS flow 1 and a multicast TMGI 1.

The correspondence between the unicast session and the multicast service identifier is, for example, a correspondence between a unicast PDU session 1 and a multicast TMGI 1.

According to the data transmission method in this embodiment of the present disclosure, the terminal device is configured, based on the second configuration information, to receive the target service data in the second transmission manner, and receives, based on the first indication information, the target service data sent in the second transmission manner. In this way, data transmission manners can be switched and resources can be saved, thereby improving resource utilization.

Corresponding to the foregoing method embodiment, the embodiments of the present disclosure further provide a data transmission apparatus.

FIG. 4 is a schematic structural diagram of a data transmission apparatus applied to a network side device according to an embodiment of the present disclosure. A data transmission apparatus 400 applied to a network side device may include:

an obtaining module 401, configured to obtain a quantity of terminal devices and geographical location information of the terminal device, where

the terminal device is a terminal device that receives target service data in a first transmission manner; and

a determining module 402, configured to determine, based on the quantity of terminal devices and the geographical location information of the terminal device, to switch the first transmission manner to a second transmission manner, so that the network side device sends the target service data to the terminal device in the second transmission manner.

In an embodiment of the present disclosure, the determining module 402 may be further configured to:

determine, based on the quantity of terminal devices and the geographical location information of the terminal device, a network node that switches the first transmission manner to the second transmission manner, so that the network node sends the target service data to the terminal device in the second transmission manner, and the terminal device receives, in the second transmission manner, the target service data sent by the network node, where the network node is a network node that manages or serves the terminal device.

In an embodiment of the present disclosure, the data transmission apparatus applied to the network side device may further include: a first sending module, configured to send first configuration information to the network node, where the first configuration information is used by the network node to establish a data service channel, and the data service channel is used to carry the target service data sent in the second transmission manner.

In an embodiment of the present disclosure, the data transmission apparatus applied to the network side device may further include: a second sending module, configured to send second configuration information to the terminal device, where the second configuration information is used to configure the terminal device to receive the target service data in the second transmission manner.

In an embodiment of the present disclosure, the second sending module may be further configured to:

send first indication information to the terminal device, where the first indication information is used to instruct the terminal device to receive the target service data sent by the network node in the second transmission manner.

In an embodiment of the present disclosure, the first transmission manner is unicast, and the second transmission manner is multicast.

In an embodiment of the present disclosure, the geographical location information includes at least one of the following items:

a frequency currently used for receiving a unicast service, a current cell, a current working area mobile network, a current tracking area, a current corresponding base station, a current corresponding gateway, a current corresponding mobility management entity, or a current corresponding session management entity.

In an embodiment of the present disclosure, the obtaining module 401 may be configured to:

determine the quantity of terminal devices based on a quantity of bearers that are established with the terminal device for the target service data.

In an embodiment of the present disclosure, a bearer type for the target service data includes any one of the following items:

a quality of service flow, a protocol data unit session, a data radio bearer, and an evolved packet system bearer.

In an embodiment of the present disclosure, the second sending module may be configured to:

send the second configuration information to the terminal device by using broadcast signaling or dedicated signaling.

In an embodiment of the present disclosure, the second configuration information includes:

configuration information of a multimedia broadcast multicast service single frequency network sending manner, and/or configuration information of a single cell point to multipoint sending manner.

In an embodiment of the present disclosure, the configuration information of the multimedia broadcast multicast service single frequency network sending manner includes:

configuration information of a control channel in the multimedia broadcast multicast service single frequency network sending manner and configuration information of a data channel in the multimedia broadcast multicast service single frequency network sending manner.

In an embodiment of the present disclosure, the configuration information of the single cell point to multipoint sending manner includes:

configuration information of a control channel in the single cell point to multipoint sending manner and configuration information of a data channel in the single cell point to multipoint sending manner.

In an embodiment of the present disclosure, the first transmission manner is multicast, and the second transmission manner is unicast.

In an embodiment of the present disclosure, the geographical location information includes at least one of the following items:

a frequency currently used for receiving a multicast service, a current cell, a current multicast service serving area, or a current multicast area.

In an embodiment of the present disclosure, the obtaining module 401 may be configured to:

send multicast service statistics request information for the target service data to the terminal device;

receive a request response that is for the multicast service statistics request information sent by the terminal device; and

count, based on the request response, a quantity of terminal devices that receive the target service data through multicast.

In an embodiment of the present disclosure, the obtaining module 401 may be configured to:

receive a first message sent by the terminal device; and

count, based on the first message, a quantity of terminal devices that receive the target service data through multicast.

In an embodiment of the present disclosure, the first message includes at least one of the following items:

identifier information of a multicast service that is currently being received, identifier information of a to-be-received multicast service, identifier information of a multicast service that is not currently received, identifier information of a multicast service that is not to be received, or identifier information of a multicast service that has been received.

In an embodiment of the present disclosure, the second sending module may be configured to:

send the second configuration information to the terminal device by using dedicated signaling.

In an embodiment of the present disclosure, the first indication information includes at least one of the following items:

a correspondence between a unicast data channel and a multicast data channel of the target service data;

service identifier information that is to be used for sending in the second transmission manner;

service identifier information that is currently used for sending in the first transmission manner;

indication information indicating that sending of the target service data in the first transmission manner is about to stop; or

indication information indicating that sending of the target service data in the second transmission manner is to be started.

In an embodiment of the present disclosure, the correspondence between the unicast data channel and the multicast data channel of the target service data includes at least one of the following items:

a correspondence between a data radio bearer and a multicast radio bearer;

a correspondence between a unicast session and a multicast session;

a correspondence between a unicast data flow and a multicast data flow;

a correspondence between a data radio bearer and multicast service identifier information;

a correspondence between a unicast data flow and a multicast service identifier; or

a correspondence between a unicast session and a multicast service identifier.

In an embodiment of the present disclosure, the data transmission apparatus applied to the network side device may further include:

a first stopping module, configured to stop sending the target service data to the terminal device in the first transmission manner.

In an embodiment of the present disclosure, the first stopping module may be configured to perform at least one of the following items:

deleting a radio bearer of the first transmission manner of the target service data, deleting an evolved packet system bearer of the first transmission manner of the target service data, deleting a quality of service flow of the first transmission manner of the target service data, deleting a protocol data unit session of the first transmission manner of the target service data, or deleting the target service data.

In an embodiment of the present disclosure, the data transmission apparatus applied to the network side device may further include: a receiving module, configured to receive second indication information sent by the terminal device, where the second indication information is used to indicate that the terminal device has been configured to receive the target service data in the second transmission manner.

In an embodiment of the present disclosure, the second indication information includes at least one of the following items:

terminal device identifier information, unicast bearer identifier information, multicast bearer identifier information, multicast service identifier information, cell identifier information for carrying a multicast service, or frequency identifier information for carrying a multicast service.

In an embodiment of the present disclosure, the second sending module may be further configured to:

send the target service data to the terminal device in the second transmission manner and the first transmission manner.

In an embodiment of the present disclosure, the receiving module may be further configured to:

receive third indication information sent by the terminal device, where the third indication information is used to indicate that the terminal device has stopped receiving the target service data in the first transmission manner.

In an embodiment of the present disclosure, the network side device includes at least one of the following items:

a base station, a gateway, a mobility management entity, or a session management entity.

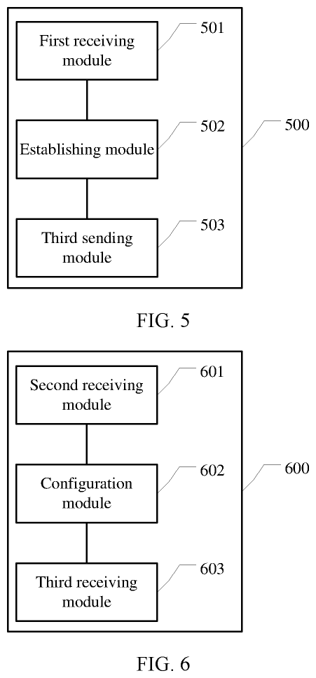

FIG. 5 is a schematic structural diagram of a data transmission apparatus applied to a network node according to an embodiment of the present disclosure. A data transmission apparatus 500 applied to a network node may include:

a first receiving module 501, configured to receive first configuration information sent by a network side device;

an establishing module 502, configured to establish a data service channel based on the first configuration information, where

the data service channel is used to carry target service data sent in a second transmission manner; and

a third sending module 503, configured to send the target service data to a terminal device in the second transmission manner based on the data service channel.

In an embodiment of the present disclosure, the data transmission apparatus applied to the network node provided in this embodiment of the present disclosure may further include:

a first stopping module, configured to stop sending the target service data to the terminal device in a first transmission manner.

In an embodiment of the present disclosure, the first stopping module may be configured to perform at least one of the following items:

deleting a radio bearer of the first transmission manner of the target service data, deleting an evolved packet system bearer of the first transmission manner of the target service data, deleting a quality of service flow of the first transmission manner of the target service data, deleting a protocol data unit session of the first transmission manner of the target service data, or deleting the target service data.

In an embodiment of the present disclosure, the first receiving module 501 may be further configured to:

receive fourth indication information sent by the terminal device, where the fourth indication information is used to indicate that the terminal device has been configured to receive the target service data in the second transmission manner.

In an embodiment of the present disclosure, the fourth indication information includes at least one of the following items:

terminal device identifier information, unicast bearer identifier information, multicast bearer identifier information, multicast service identifier information, cell identifier information for carrying a multicast service, or frequency identifier information for carrying a multicast service.

In an embodiment of the present disclosure, the third sending module 503 may be further configured to:

send the target service data to the terminal device in the second transmission manner and the first transmission manner.

In an embodiment of the present disclosure, the first receiving module 501 may be further configured to:

receive fifth indication information sent by the terminal device, where the fifth indication information is used to indicate that the terminal device has stopped receiving the target service data in the first transmission manner.

FIG. 6 is a schematic structural diagram of a data transmission apparatus applied to a terminal device according to an embodiment of the present disclosure. A data transmission apparatus 600 applied to a terminal device may include:

a second receiving module 601, configured to receive second configuration information and/or first indication information sent by a network side device;

a configuration module 602, configured to configure, based on the second configuration information, to receive target service data in a second transmission manner; and

a third receiving module 603, configured to receive, based on the first indication information, the target service data sent in the second transmission manner.

In an embodiment of the present disclosure, the data transmission apparatus applied to the terminal device provided in this embodiment of the present disclosure may further include:

a second stopping module, configured to stop receiving the target service data sent in a first transmission manner.

In an embodiment of the present disclosure, the second stopping module may be configured to:

actively stop receiving the target service data sent in the first transmission manner; or

receive sixth indication information sent by the network side device, where the sixth indication information is used to instruct the terminal device to stop receiving the target service data sent in the first transmission manner; and stop, based on the sixth indication information, receiving the target service data sent in the first transmission manner.

In an embodiment of the present disclosure, the data transmission apparatus applied to the terminal device provided in this embodiment of the present disclosure may further include:

a fourth sending module, configured to send seventh indication information to the network side device and/or a network node, where the seventh indication information is used to indicate that the terminal device has stopped receiving the target service data in the first transmission manner.

In an embodiment of the present disclosure, the seventh indication information includes at least one of the following items:

a bearer identifier of the first transmission manner, a bearer identifier of the second transmission manner, a service identifier of the second transmission manner, a cell identifier for carrying the second transmission manner, or a frequency identifier for carrying the second transmission manner.

In an embodiment of the present disclosure, the data transmission apparatus applied to the terminal device provided in this embodiment of the present disclosure may further include:

a fifth sending module, configured to send eighth indication information to the network side device and/or a network node, where the eighth indication information is used to indicate that the terminal device has been configured to receive the target service data in the second transmission manner.

In an embodiment of the present disclosure, the eighth indication information includes at least one of the following items:

terminal device identifier information, unicast bearer identifier information, multicast bearer identifier information, multicast service identifier information, cell identifier information for carrying a multicast service, or frequency identifier information for carrying a multicast service.

In an embodiment of the present disclosure, the first indication information includes at least one of the following items:

a correspondence between a unicast data channel and a multicast data channel of the target service data;

service identifier information that is to be used for sending in the second transmission manner;

identifier information that is of the target service data and that is to be used for sending in the second transmission manner;

indication information indicating that the first transmission manner of the target service data is about to stop; or

indication information indicating that the second transmission manner of the target service data is to be started.

In an embodiment of the present disclosure, the correspondence between the unicast data channel and the multicast data channel of the target service data includes at least one of the following items:

a correspondence between a data radio bearer and a multicast radio bearer;

a correspondence between a unicast session and a multicast session;

a correspondence between a unicast data flow and a multicast data flow;

a correspondence between a data radio bearer and multicast service identifier information;

a correspondence between a unicast data flow and a multicast service identifier; or

a correspondence between a unicast session and a multicast service identifier.

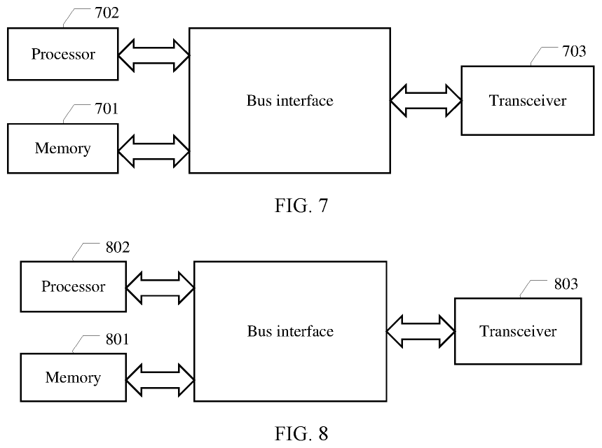

FIG. 7 is a schematic diagram of a hardware structure of a network side device according to an embodiment of the present disclosure. The network side device includes: a memory 701, a processor 702, a transceiver 703, and a computer program that is stored in the memory 701 and executable on the processor 702.

The processor 702 may be configured to: obtain a quantity of terminal devices and geographical location information of the terminal device; and determine, based on the quantity of terminal devices and the geographical location information of the terminal device, to switch a first transmission manner to a second transmission manner.

A process in which the processor 702 determines to switch the first transmission manner to the second transmission manner is basically the same as the process of switching the first transmission manner to the second transmission manner in the foregoing method embodiment. For details, refer to the descriptions in the foregoing method embodiment. Details are not described again in this embodiment of the present disclosure.

In FIG. 7, a bus architecture may include any quantity of interconnected buses and bridges, and may link various circuits of one or more processors represented by the processor 702 and a memory represented by the memory 701. The bus architecture may further link various other circuits such as a peripheral device, a voltage regulator, and a power management circuit. These are well known in the art, and therefore are not further described in this specification. A bus interface provides an interface. The transceiver 703 may be a plurality of elements, for example, include a transmitter and a transceiver, and provide a unit configured to communicate with various other apparatuses on a transmission medium, and is configured to receive and send data under the control of the processor 702. The processor 702 is responsible for bus architecture management and general processing. The memory 701 may store data used by the processor 702 when the processor 702 performs an operation.

Optionally, an embodiment of the present disclosure further provides a network side device, including: a processor 702, a memory 701, and a computer program that is stored in the memory 701 and executable on the processor 702. When the computer program is executed by the processor 702, the processes of the data transmission method embodiment applied to the network side device are implemented, and a same technical effect can be achieved. To avoid repetition, details are not described herein again.

FIG. 8 is a schematic diagram of a hardware structure of a network node according to an embodiment of the present disclosure. The network node includes: a memory 801, a processor 802, a transceiver 803, and a computer program that is stored in the memory 801 and executable on the processor 802.

The transceiver 803 may be configured to: receive first configuration information sent by a network side device; and send target service data to a terminal device in a second transmission manner based on a data service channel.

The processor 802 may be configured to establish the data service channel based on the first configuration information, where the data service channel is used to carry the target service data sent in the second transmission manner.

A process in which the transceiver 803 receives the first configuration information sent by the network side device is basically the same as the process of receiving the first configuration information sent by the network side device in the foregoing method embodiment. For details, refer to the descriptions in the foregoing method embodiment. Details are not described again in this embodiment of the present disclosure.

A process in which the processor 802 establishes the data service channel is basically the same as the process of establishing the data service channel in the foregoing method embodiment. For details, refer to the descriptions in the foregoing method embodiment. Details are not described again in this embodiment of the present disclosure.

In FIG. 8, a bus architecture may include any quantity of interconnected buses and bridges, and may link various circuits of one or more processors represented by the processor 802 and a memory represented by the memory 801. The bus architecture may further link various other circuits such as a peripheral device, a voltage regulator, and a power management circuit. These are well known in the art, and therefore are not further described in this specification. A bus interface provides an interface. The transceiver 803 may be a plurality of elements, for example, include a transmitter and a transceiver, and provide a unit configured to communicate with various other apparatuses on a transmission medium, and is configured to receive and send data under the control of the processor 802. The processor 802 is responsible for bus architecture management and general processing. The memory 801 may store data used by the processor 802 when the processor 802 performs an operation.

Optionally, an embodiment of the present disclosure further provides a network node, including: a processor 802, a memory 801, and a computer program that is stored in the memory 801 and executable on the processor 802. When the computer program is executed by the processor 802, the processes of the data transmission method embodiment applied to the network node are implemented, and a same technical effect can be achieved. To avoid repetition, details are not described herein again.

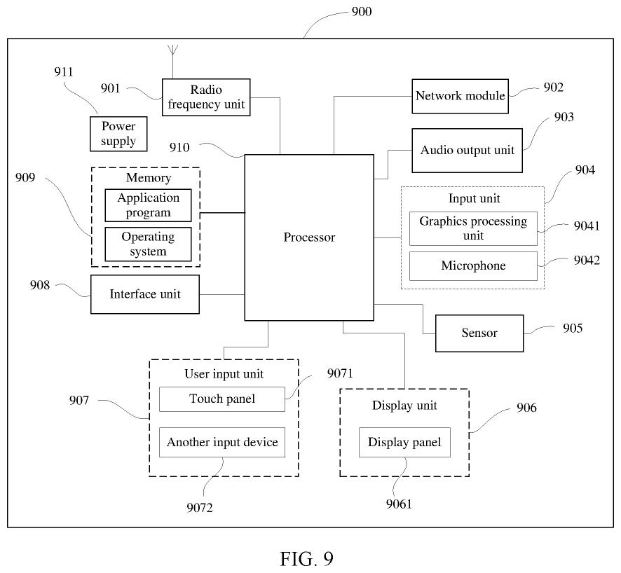

FIG. 9 is a schematic diagram of a hardware structure of a terminal device according to an embodiment of the present disclosure. A terminal device 900 includes but is not limited to components such as a radio frequency unit 901, a network module 902, an audio output unit 903, an input unit 904, a sensor 905, a display unit 906, a user input unit 907, an interface unit 908, a memory 909, a processor 910, and a power supply 911. It can be understood by a person skilled in the art that, the terminal device structure shown in FIG. 9 does not constitute any limitation on the terminal device, and the terminal device may include more or fewer components than those shown in the figure, or combine some components, or have different component arrangements. In this embodiment of the present disclosure, the terminal device includes but is not limited to a mobile phone, a tablet computer, a notebook computer, a palmtop computer, an in-vehicle terminal, a wearable device, a pedometer, and the like.

The radio frequency unit 901 may be configured to: receive second configuration information and/or first indication information sent by a network side device; and receive, based on the first indication information, target service data sent in a second transmission manner.

The processor 910 may be configured to configure, based on the second configuration information, to receive the target service data in the second transmission manner.

A process in which the radio frequency unit 901 receives the target service data is basically the same as the process of receiving the target service data in the foregoing method embodiment. For details, refer to the descriptions in the foregoing method embodiment. Details are not described again in this embodiment of the present disclosure.

A process in which the processor 910 is configured to receive the target service data in the second transmission manner is basically the same as the process of configuring to receive the target service data in the second transmission manner in the foregoing method embodiment. For details, refer to the descriptions in the foregoing method embodiment. Details are not described again in this embodiment of the present disclosure.

It should be understood that, in this embodiment of the present disclosure, the radio frequency unit 901 may be configured to receive and send information or a signal in a call process. For example, after receiving downlink data from a base station, the radio frequency unit 901 sends the downlink data to the processor 910 for processing. In addition, the radio frequency unit 901 sends uplink data to the base station. Usually, the radio frequency unit 901 includes but is not limited to an antenna, at least one amplifier, a transceiver, a coupler, a low noise amplifier, a duplexer, and the like. In addition, the radio frequency unit 901 may communicate with a network and another device through a wireless communication system.

The terminal device provides wireless broadband Internet access for the user by using the network module 902, for example, helping the user to send and receive an e-mail, brows a web page, and access streaming media.

The audio output unit 903 may convert audio data received by the radio frequency unit 901 or the network module 902 or stored in the memory 909 into an audio signal and output the audio signal as a sound. In addition, the audio output unit 903 may further provide an audio output (for example, a call signal received voice, or a message received voice) related to a specific function implemented by the terminal device 900. The audio output unit 903 includes a speaker, a buzzer, a telephone receiver, and the like.

The input unit 904 is configured to receive an audio signal or a video signal. The input unit 904 may include a graphics processing unit (GPU) 9041 and a microphone 9042, and the graphics processing unit 9041 processes image data of a still picture or video obtained by an image capture apparatus (such as a camera) in a video capture mode or an image capture mode. A processed image frame may be displayed on the display unit 906. The image frame processed by the graphics processing unit 9041 may be stored in the memory 909 (or another storage medium) or sent by using the radio frequency unit 901 or the network module 902. The microphone 9042 may receive a sound and can process such sound into audio data. Processed audio data may be converted, in a call mode, into a format that can be sent to a mobile communication base station by using the radio frequency unit 901 for output.

The terminal device 900 further includes at least one sensor 905, such as an optical sensor, a motion sensor, and other sensors. The light sensor includes an ambient light sensor and a proximity sensor. The ambient light sensor may adjust luminance of the display panel 9061 based on brightness of ambient light. The proximity sensor may turn off the display panel 9061 and/or backlight when the terminal device 900 moves to an ear. As a type of the motion sensor, an accelerometer sensor may detect an acceleration value in each direction (generally, three axes), and detect a value and a direction of gravity when the accelerometer sensor is static, and may be used in an application for recognizing a posture of the terminal device (such as screen switching between landscape and portrait modes, a related game, or magnetometer posture calibration), a function related to vibration recognition (such as a pedometer or a knock), and the like. The sensor 905 may further include a fingerprint sensor, a pressure sensor, an iris sensor, a molecular sensor, a gyroscope, a barometer, a hygrometer, a thermometer, an infrared sensor, and the like. Details are not described herein.

The display unit 906 is configured to display information entered by a user or information provided for a user. The display unit 906 may include a display panel 9061. The display panel 9061 may be configured in a form of a liquid crystal display (LCD), an organic light-emitting diode (OLED), or the like.

The user input unit 907 may be configured to receive input digit or character information, and generate a key signal input related to a user setting and function control of the terminal device. The user input unit 907 includes a touch panel 9071 and another input device 9072. The touch panel 9071 is also referred to as a touchscreen, and may collect a touch operation performed by a user on or near the touch panel 9071 (such as an operation performed by a user on or near the touch panel 9071 by using any proper object or accessory, such as a finger or a stylus). The touch panel 9071 may include two parts: a touch detection apparatus and a touch controller. The touch detection apparatus detects a touch location of the user, detects a signal brought by the touch operation, and sends the signal to the touch controller. The touch controller receives touch information from the touch detection apparatus, converts the touch information into touch point coordinates, and sends the touch point coordinates to the processor 910, and can receive and execute a command sent by the processor 910. In addition, the touch panel 9071 may be of a resistive type, a capacitive type, an infrared type, a surface acoustic wave type, or the like. The user input unit 907 may include another input device 9072 in addition to the touch panel 9071. The another input device 9072 may include but is not limited to a physical keyboard, a functional button (such as a volume control button or a power on/off button), a trackball, a mouse, and a joystick. Details are not described herein.

Optionally, the touch panel 9071 may cover the display panel 9061. When detecting the touch operation on or near the touch panel 9071, the touch panel 9071 transmits the touch operation to the processor 910 to determine a type of a touch event, and then the processor 910 provides corresponding visual output on the display panel 9061 based on the type of the touch event. In FIG. 9, although the touch panel 9071 and the display panel 9061 are used as two independent parts to implement input and output functions of the terminal device, in some embodiments, the touch panel 9071 and the display panel 9061 may be integrated to implement the input and output functions of the terminal device. This is not specifically limited herein.

The interface unit 908 is an interface for connecting an external apparatus with the terminal device 900. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, a headset port, and the like. The interface unit 908 may be configured to receive input (for example, data information and power) from an external apparatus and transmit the received input to one or more elements in the terminal device 900 or may be configured to transmit data between the terminal device 900 and an external apparatus.

The memory 909 may be configured to store a software program and various data. The memory 909 may mainly include a program storage area and a data storage area. The program storage area may store an operating system, an application program required by at least one function (such as a sound play function or an image play function), and the like. The data storage area may store data (such as audio data or an address book) created based on use of the mobile phone, and the like. In addition, the memory 909 may include a high-speed random access memory, and may further include a nonvolatile memory, for example, at least one magnetic disk storage device, a flash storage device, or another volatile solid-state storage device.

The processor 910 is a control center of the terminal device, is connected to each part of the entire terminal device by using various interfaces and lines, and performs various functions of the terminal device and data processing by running or executing the software program and/or the module that are/is stored in the memory 909 and invoking data stored in the memory 909, to perform overall monitoring on the terminal device. The processor 910 may include one or more processing units. Optionally, an application processor and a modem processor may be integrated into the processor 910. The application processor mainly processes an operating system, a user interface, an application program, and the like. The modem processor mainly processes wireless communications. It can be understood that, alternatively, the modem processor may not be integrated into the processor 910.

The terminal device 900 may further include the power supply 911 (such as a battery) that supplies power to each component. Optionally, the power supply 911 may be logically connected to the processor 910 by using a power supply management system, so as to implement functions such as charging and discharging management, and power consumption management by using the power supply management system.

In addition, the terminal device 900 includes some function modules not shown, and details are not described herein.

Optionally, an embodiment of the present disclosure further provides a terminal device, including: a processor 910, a memory 909, and a computer program that is stored in the memory 909 and executable on the processor 910. When the computer program is executed by the processor 910, the foregoing processes of the data transmission method embodiment applied to the terminal device are implemented, and a same technical effect can be achieved. To avoid repetition, details are not described herein again.

An embodiment of the present disclosure further provides a computer-readable storage medium, and the computer-readable storage medium stores a computer program instruction. When the computer program instruction is executed by a processor, the processes of the of the data transmission method embodiment applied to the network side device, or the processes of the data transmission method embodiment applied to the network side device, or the processes of the data transmission method embodiment applied to the terminal device provided in the embodiments of the present disclosure are implemented, and a same technical effect can be achieved. To avoid repetition, details are not described herein again. An example of the computer-readable storage medium includes a non-transitory computer-readable storage medium, such as a read-only memory (ROM), a random access memory (RAM), a magnetic disk, or an optical disc.

The foregoing describes the aspects of the present disclosure with reference to flowcharts and/or block diagrams of the method, the apparatus (system), and the computer program product according to the embodiments of the present disclosure. It should be understood that each block in the flowchart and/or block diagram and a combination of blocks in the flowchart and/or block diagram may be implemented by a computer program instruction. These computer program instructions may be provided for a general-purpose computer, a dedicated computer, or a processor of another programmable data processing apparatus to generate a machine, so that when these instructions are executed by the computer or the processor of the another programmable data processing apparatus, specific functions/actions in one or more blocks in the flowcharts and/or in the block diagrams are implemented. The processor may be but is not limited to a general purpose processor, a dedicated processor, a special application processor, or a field programmable logic circuit. It should be further understood that each block in the block diagram or the flowchart and a combination of blocks in the block diagram or the flowchart may be implemented by using dedicated hardware that performs a specified function or operation, or may be implemented by using a combination of dedicated hardware and a computer instruction.

It should be noted that, although the foregoing embodiments have been described in this specification, the patent protection scope of the present disclosure is not limited thereto. Therefore, based on the innovation concept of the present disclosure, the foregoing technical solutions are directly or indirectly applied to other related technical fields through changes and modifications to the embodiments described in the present disclosure or through equivalent structure or equivalent process transformation made in this specification and the accompanying drawings, which are all included in the protection scope of the present disclosure.

What is claimed is:

1. A data transmission method, applied to a network side device, wherein the method comprises:
obtaining a quantity of terminal devices and geographical location information of a terminal device, wherein the terminal device is a terminal device that receives target service data in a first transmission manner; and
determining, based on the quantity of terminal devices and the geographical location information of the terminal device, to switch the first transmission manner to a second transmission manner, so that the network side device sends the target service data to the terminal device in the second transmission manner.

2. The method according to claim 1, wherein the method further comprises:
determining, based on the quantity of terminal devices and the geographical location information of the terminal device, a network node that switches the first transmission manner to the second transmission manner, so that the network node sends the target service data to the terminal device in the second transmission manner, and the terminal device receives, in the second transmission manner, the target service data sent by the network node, wherein the network node is a network node that manages or serves the terminal device.

3. The method according to claim 2, wherein the method further comprises:
sending first configuration information to the network node, wherein the first configuration information is used by the network node to establish a data service channel, and the data service channel is used to carry the target service data sent in the second transmission manner.

4. The method according to claim 1, wherein the method further comprises:
sending second configuration information to the terminal device, wherein the second configuration information is used to configure the terminal device to receive the target service data in the second transmission manner; and/or
sending first indication information to the terminal device, wherein the first indication information is used to instruct the terminal device to receive the target service data sent in the second transmission manner.

5. The method according to claim 1, wherein the first transmission manner is unicast, and the second transmission manner is multicast.

6. The method according to claim 5, wherein the geographical location information comprises at least one of:
a frequency currently used for receiving a unicast service, a current cell, a current working area mobile network, a current tracking area, a current corresponding base station, a current corresponding gateway, a current corresponding mobility management entity, or a current corresponding session management entity.

7. The method according to claim 5, wherein the obtaining a quantity of terminal devices comprises:
determining the quantity of terminal devices based on a quantity of bearers that are established with the terminal device for the target service data.

8. The method according to claim 4, wherein the second configuration information comprises:
configuration information of a multimedia broadcast multicast service single frequency network sending manner, and/or configuration information of a single cell point to multipoint sending manner.

9. The method according to claim 1, wherein the first transmission manner is multicast, and the second transmission manner is unicast.

10. The method according to claim 9, wherein the geographical location information comprises at least one of:
a frequency currently used for receiving a multicast service, a current cell, a current multicast service serving area, or a current multicast area.

11. The method according to claim 9, wherein the obtaining a quantity of terminal devices comprises:
sending multicast service statistics request information for the target service data to a terminal device;
receiving a request response for the multicast service statistics request information sent by a terminal device; and
counting, based on the request response, a quantity of terminal devices that receive the target service data through multicast; or
the obtaining a quantity of terminal devices comprises:
receiving a first message sent by a terminal device; and
counting, based on the first message, a quantity of terminal devices that receive the target service data through multicast.

12. The method according to claim 10, wherein the first message comprises at least one of:
identifier information of a multicast service that is currently being received, identifier information of a to-be-received multicast service, identifier information of a multicast service that is not currently received, identifier information of a multicast service that is not to be received, or identifier information of a multicast service that has been received.

13. The method according to claim 4, wherein the first indication information comprises at least one of:
a correspondence between a unicast data channel and a multicast data channel of the target service data;
service identifier information that is to be used for sending in the second transmission manner;
service identifier information that is currently used for sending in the first transmission manner;
indication information indicating that sending of the target service data in the first transmission manner is about to stop; or
indication information indicating that sending of the target service data in the second transmission manner is to be started.

14. The method according to claim 13, wherein the correspondence between the unicast data channel and the multicast data channel of the target service data comprises at least one of:
a correspondence between a data radio bearer and a multicast radio bearer;
a correspondence between a unicast session and a multicast session;
a correspondence between a unicast data flow and a multicast data flow;
a correspondence between a data radio bearer and multicast service identifier information;
a correspondence between a unicast data flow and a multicast service identifier; or
a correspondence between a unicast session and a multicast service identifier.

15. The method according to claim 1, wherein the method further comprises:
sending the target service data to the terminal device in the second transmission manner.

16. The method according to claim 19, wherein before the sending the target service data to the terminal device in the second transmission manner, the method further comprises:
stopping sending the target service data to the terminal device in the first transmission manner; and/or
before the sending the target service data to the terminal device in the second transmission manner, the method further comprises:
sending the target service data to the terminal device in the second transmission manner and the first transmission manner.

17. The method according to claim 16, wherein the stopping sending the target service data to the terminal device in the first transmission manner comprises at least one of:
deleting a radio bearer of the first transmission manner of the target service data, deleting an evolved packet system bearer of the first transmission manner of the target service data, deleting a quality of service flow of the first transmission manner of the target service data, deleting a protocol data unit session of the first transmission manner of the target service data, or deleting the target service data.

18. The method according to claim 16, wherein before the stopping sending the target service data to the terminal device in the first transmission manner, the method further comprises:
receiving second indication information sent by the terminal device, wherein the second indication information is used to indicate that the terminal device has been configured to receive the target service data in the second transmission manner; and/or
before the stopping sending the target service data to the terminal device in the first transmission manner, the method further comprises:
receiving third indication information sent by the terminal device, wherein the third indication information is used to indicate that the terminal device has stopped receiving the target service data in the first transmission manner.

19. A data transmission method, applied to a network node, wherein the method comprises:
receiving first configuration information sent by a network side device;
establishing a data service channel based on the first configuration information, wherein the data service channel is used to carry target service data sent in a second transmission manner; and
sending the target service data to a terminal device in the second transmission manner based on the data service channel.

20. A data transmission method, applied to a terminal device, wherein the method comprises:
receiving second configuration information and/or first indication information sent by a network side device;
configuring, based on the second configuration information, to receive target service data in a second transmission manner; and
receiving, based on the first indication information, the target service data sent in the second transmission manner.
